(19) United States
(12) Patent Application Publication
(10) Pub. No.: US 2024/0273640 A1
(43) Pub. Date: Aug. 15, 2024

(54) DATING RECOMMENDATION PLATFORM AND OPERATION METHOD OF THE SAME

(71) Applicant: ELECTRONICS AND TELECOMMUNICATIONS RESEARCH INSTITUTE, Daejeon (KR)

(72) Inventors: Jeong Muk LIM, Daejeon (KR); Kyoung Ju NOH, Daejeon (KR); SEUNG EUN CHUNG, Daejeon (KR); Hyun Tae JEONG, Daejeon (KR)

(21) Appl. No.: 18/417,038

(22) Filed: Jan. 19, 2024

(30) Foreign Application Priority Data
Feb. 9, 2023 (KR) 10-2023-0017452

(51) Int. Cl. G06Q 50/00

(52) U.S. Cl. CPC G06Q 50/01

(57) ABSTRACT

Disclosed is a dating recommendation platform including a first server that receives first data and second data from an external electronic device, generates time-series data including characteristic data generated for each period in response to the first data and the second data by analyzing the second data, and generates personal preference data by performing classifications from the first to the seventh based on the time-series data, and a second server that receives the personal preference data from the first server, anonymizes the first data included in the personal preference data, generates image data based on the anonymized personal preference data, and outputs the generated image data to the external electronic device. The characteristic data includes information about at least one of an action, an emotion, a place, a speech, a movement, and a circumstance of a user.

### CROSS-REFERENCE TO RELATED APPLICATION(S)

This application claims priority under 35 U.S.C. § 119 to Korean Patent Application No. 10-2023-0017452 filed on Feb. 9, 2023, in the Korean Intellectual Property Office, the disclosures of which are incorporated by reference herein in their entireties.

### BACKGROUND

### 1. Field of the Invention

Embodiments of the present disclosure described herein relate to a dating recommendation system, and more particularly, relate to a dating recommendation platform that outputs personal preference data corresponding to a user input as image data among personal preference data based on collected data, and an operating method thereof.

### 2. Description of Related Art

A dating recommendation system refers to a system that manages user information for the purpose of dating in a database and connects a user and a dater by reflecting a user's preference for the dater.

The dating recommendation system collects, from the user, first information about the user's gender, age, area of residence, education, occupation, income level, and family relationship, second information about requirements for dater, and third information about the user's personality and life patterns online and offline, and generates the database based on the collected information.

However, when the dating recommendation system collects the user's third information online and offline, it may be difficult to guarantee the reliability of the collected third information as compared to the collected first information and the collected second information. Accordingly, there may be a need for a method for providing a dating recommendation service based on third information capable of guaranteeing reliability.

### SUMMARY

Embodiments of the present disclosure provide a dating recommendation platform that is capable of providing a dating recommendation service by outputting personal preference data, which is generated based on data collected in real time, as image data, and an operating method thereof.

According to an embodiment, a dating recommendation platform includes a first server that receives first data and second data from an external electronic device, generates time-series data including characteristic data generated for each period in response to the first data and the second data by analyzing the second data, and generates personal preference data by performing a first classification, a second classification, a third classification, a fourth classification, a fifth classification, a sixth classification, and a seventh classification based on the time-series data, and a second server that receives the personal preference data from the first server, anonymizes the first data included in the personal preference data, generates image data based on the anonymized personal preference data, and outputs the generated image data to the external electronic device. The characteristic data includes information about at least one of an action, an emotion, a place, a speech, a movement, and a circumstance of a user.

In an embodiment, the first data includes information about at least one of a gender, an age, an area of residence, and an education of the user, and the second data includes sensor data obtained from sensors included in the external electronic device, user data obtained from an application of the external electronic device, and system data obtained from a device system included in the external electronic device.

In an embodiment, first time-series data including the place of the user is generated based on information about the circumstance of the user, and second time-series data including the emotion of the user is generated based on information about the speech of the user.

In an embodiment, the first server generates first characteristic data during a first period, generates second characteristic data during a second period, and generates third characteristic data during a third period. The first classification includes a classification of a life pattern of the user. The first server performs the first classification based on the first characteristic data, the second characteristic data, and the third characteristic data, and a start time point and an end time point of each of the first period, the second period, and the third period.

In an embodiment, the second classification includes a classification of first time-series data including the place of the user. The first time-series data includes first place group data and second place group data. The first place group data has a category value based on a change value of characteristic data for the place generated during a first time period. The second place group data has a category value corresponding to the number of places generated during a second time period.

In an embodiment, the third classification includes a classification for second time-series data including the emotion of the user. The second time-series data includes first emotion group data and second emotion group data. The first emotion group data has a category value based on a change value of characteristic data for the emotion generated during a first time period. The second emotion group data has a category value based on a change value of characteristic data for the emotion generated during a second time period.

In an embodiment, the fourth classification includes a classification for third time-series data including the speech of the user. The third time-series data includes first speech group data and second speech group data. The first speech group data has a category value based on an average value of characteristic data for the speech generated during a first time period. The second speech group data has a category value based on a change value of characteristic data for the speech generated during a second time period.

In an embodiment, the fifth classification includes a classification for fourth time-series data including the action of the user. The fourth time-series data includes first action group data and second action group data. The first action group data has a category value based on characteristic data for the action generated during a first time period. The second action group data has a category value based on characteristic data for the action generated during a second time period.

In an embodiment, the sixth classification includes a classification for fifth time-series data including the movement of the user. The fifth time-series data includes first movement group data and second movement group data. The first movement group data has a category value based on a change value of characteristic data for the movement generated during a first time period. The second movement group data has a category value based on an average value of characteristic data for the movement generated during a second time period.

In an embodiment, the seventh classification includes a classification for sixth time-series data including the circumstance of the user. The sixth time-series data includes first circumstance group data and second circumstance group data. The first circumstance group data has a category value based on a change value of characteristic data for the circumstance generated during a first time period. The second circumstance group data has a category value based on an average value of characteristic data for the circumstance generated during a second time period.

In an embodiment, the second server outputs the anonymized personal preference data to the external electronic device. The second server receives a user input including selection of a candidate avatar and selection of the anonymized personal preference data from the external electronic device. The second server outputs the image data corresponding to the selected personal preference data for the selected candidate avatar to the external electronic device.

According to an embodiment, an operating method of a dating recommendation platform including a first server and a second server includes receiving, by the first server, first data and second data from an external electronic device, generating, by the first server, time-series data corresponding to the first data and the second data by analyzing the second data, generating, by the first server, personal preference data by performing a first classification, a second classification, a third classification, a fourth classification, and a fifth classification based on the time-series data, anonymizing, by the second server, the first data included in the personal preference data, generating, by the second server, image data based on the anonymized personal preference data, and outputting, by the second server, the generated image data to the external electronic device.

In an embodiment, the time-series data includes characteristic data generated for the respective period in response to the second data. The characteristic data includes information about at least one of an action, an emotion, a place, a speech, a movement, and a circumstance of a user.

In an embodiment, the generating of the time-series data includes generating, by the first server, first characteristic data during a first period, generating second characteristic data during a second period, and generating third characteristic data during a third period. The generating of the personal preference data includes performing, by the first server, a first classification on a life pattern of the user based on the first characteristic data, the second characteristic data, and the third characteristic data, and a start time point and an end time point of each of the first period, the second period, and the third period.

In an embodiment, the performing of the second classification includes classifying, by the first server, first time-series data including the action of the user. The first time-series data includes first action group data and second action group data. The first action group data has a category value based on characteristic data for the action generated during a first time period. The second action group data has a category value based on characteristic data for the action generated during a second time period.

In an embodiment, the performing of the third classification includes classifying, by the first server, second time-series data including the movement of the user. The second time-series data includes first movement group data and second movement group data. The first movement group data has a category value based on a change value of characteristic data for the movement generated during a first time period. The second movement group data has a category value based on an average value of characteristic data for the movement generated during a second time period.

In an embodiment, third time-series data including the place of the user is generated based on information about the circumstance of the user. Fourth time-series data including the emotion of the user is generated based on information about the speech of the user.

In an embodiment, the performing of the fourth classification includes classifying, by the first server, the third time-series data including the place of the user. The third time-series data includes first place group data and second place group data. The first place group data has a category value based on a change value of characteristic data for the place generated during a first time period. The second place group data has a category value corresponding to the number of places generated during a second time period.

In an embodiment, the performing of the fifth classification includes classifying, by the first server, the fourth time-series data including the emotion of the user. The fourth time-series data includes first emotion group data and second emotion group data. The first emotion group data has a category value based on a change value of characteristic data for the emotion generated during a first time period. The second emotion group data has a category value based on a change value of characteristic data for the emotion generated during a second time period.

In an embodiment, the method further includes outputting, by the second server, the anonymized personal preference data to the external electronic device, receiving, by the second server, a user input including selection of a candidate avatar and selection of the anonymized personal preference data from the external electronic device, and outputting, by the second server, the image data corresponding to the selected personal preference data for the selected candidate avatar to the external electronic device.

### BRIEF DESCRIPTION OF THE DRAWINGS

The above and other objects and features of the present disclosure will become apparent by describing in detail embodiments thereof with reference to the accompanying drawings.

FIG. 1 is a diagram showing a system that provides a dating recommendation service, according to an embodiment of the present disclosure.

FIG. 2 is a diagram of an embodiment in which a dating recommendation platform generates time-series data.

FIG. 3 is a diagram of a first embodiment in which a dating recommendation platform classifies time-series data.

FIG. 4A is a diagram of a second embodiment in which a dating recommendation platform classifies time-series data.

FIG. 4B is a diagram of a third embodiment in which a dating recommendation platform classifies time-series data.

FIG. 4C is a diagram of a fourth embodiment in which a dating recommendation platform classifies time-series data.

FIG. 4D is a diagram of a fifth embodiment in which a dating recommendation platform classifies time-series data.

FIG. 4E is a diagram of a sixth embodiment in which a dating recommendation platform classifies time-series data.

FIG. 4F is a diagram of a seventh embodiment in which a dating recommendation platform classifies time-series data.

FIG. 5 is a diagram of an embodiment in which a dating recommendation platform generates personal preference data.

FIG. 6 is a diagram of a first example of image data output by a dating recommendation platform.

FIG. 7 is a diagram of a second example of image data output by a dating recommendation platform.

FIG. 8 is a flowchart of an operating method in which a dating recommendation platform generates personal preference data.

FIG. 9 is a flowchart of an operating method in which a dating recommendation platform outputs image data.

### DETAILED DESCRIPTION

Hereinafter, embodiments of the present disclosure may be described in detail and clearly to such an extent that an ordinary one in the art easily implements the present disclosure.

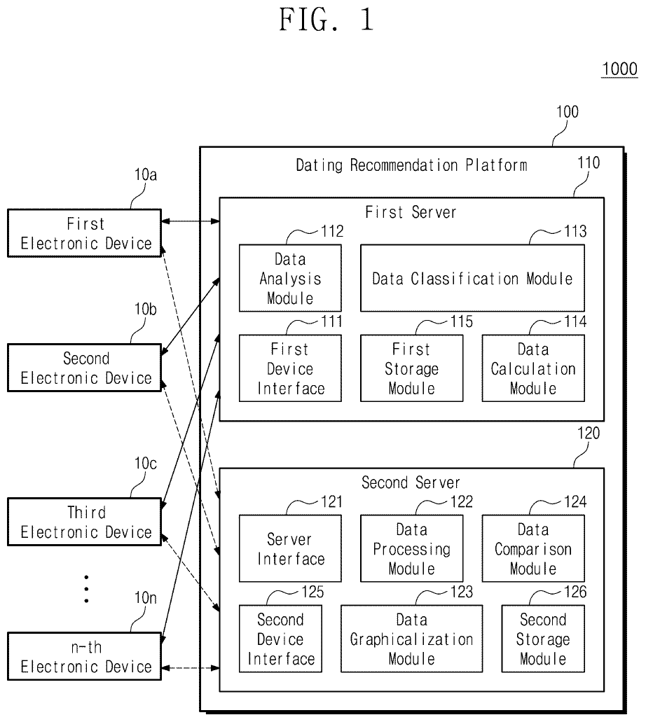

FIG. 1 is a diagram showing a system 1000 that provides a dating recommendation service, according to an embodiment of the present disclosure. Referring to FIG. 1, the system 1000, which provides a dating recommendation service, includes a dating recommendation platform 100 and a plurality of electronic devices 10a to 10n.

Each of the plurality of electronic devices 10a to 10n may be at least one of mobile devices, such as smartphones, smart watches, and tablet personal computers (PCs), or smart devices such as laptops, computers, artificial intelligence speakers, CCTV, smart lights, and thermohygrometers. However, the plurality of electronic devices 10a to 10n are not limited thereto.

An inertial measurement unit (IMU) sensor, an illuminance sensor, a barometric pressure sensor, a proximity sensor, a fingerprint sensor, a photoplethysmography (PPG) sensor, an electrodermal activity (EDA) sensor, and a thermometer, which are included in each of the plurality of electronic devices 10a to 10n, may periodically collect sensor data. Each of the plurality of electronic devices 10a to 10n may collect sensor data on a daily, weekly, or monthly basis.

A plurality of applications included in each of the plurality of electronic devices 10a to 10n may periodically collect user data including global positioning system (GPS) data, audio data, video data, life-logging data, fitness data, health data, journaling data, time management data, social network service (SNS) data, email data, and message data.

A device system included in each of the plurality of electronic devices 10a to 10n is may periodically collect system data including charger connection data, earphone and speaker output connection data, network connection data, screen lock time data, screen use time data, application use time data, and device use data.

At least some of the plurality of electronic devices 10a to 10n may periodically collect surrounding circumstance data including the user's surrounding circumstance information. The surrounding circumstance data may include at least a piece of information of a temperature, humidity, pressure, illumination, a surrounding circumstance image, and noise.

Each of the plurality of electronic devices 10a to 10n may collect first data and second data. The second data may include at least one of the sensor data, the user data, the system data, and the surrounding circumstance data, which are described above.

The first data may include information about at least one of the user's gender, age, area of residence, education, occupation, appearance, income level, and family relationship, hobby, and specialty. The first data may be stored in advance in the dating recommendation platform 100.

The dating recommendation platform 100 may receive data from an external device or external system. The dating recommendation platform 100 may include a memory (not shown) for temporarily storing received data. However, an embodiment is not limited thereto, and the dating recommendation platform 100 may include all means including a storage space capable of receiving and storing data.

The dating recommendation platform 100 may receive the first data and the second data from each of the plurality of electronic devices 10a to 10n. The dating recommendation platform 100 may include a first server 110 and a second server 120.

The first server 110 may include a first device interface 111, a data analysis module 112, a data classification module 113, a data calculation module 114, and a first storage module 115.

The first device interface 111 may provide remote communication between the first server 110 and another device not included in the first server 110. The first device interface 111 may perform wireless or wired communication between the first server 110 and the other device not included in the first server 110. The other device may be the plurality of electronic devices 10a to 10n.

The data analysis module 112 may receive the first data and the second data from each of the plurality of electronic devices 10a to 10n through the first device interface 111. The data analysis module 112 may generate characteristic data for each period based on the first data and the second data for each of the plurality of electronic devices 10a to 10n.

The characteristic data may include information about at least one of the user's action, emotion, location, speech, movement, and circumstance. The characteristic data will be described below in detail.

The data analysis module 112 may generate time-series data including characteristic data generated for each cycle of the plurality of electronic devices 10a to 10n. The time-series data may include first time-series data regarding places, second time-series data regarding emotions, third time-series data regarding speeches, fourth time-series data regarding actions, fifth time-series data regarding movements, and sixth time-series data regarding circumstances. The time-series data will be described below in detail.

The data classification module 113 may perform first to seventh classifications based on the time-series data received from the data analysis module 112 with respect to each of the plurality of electronic devices 10a to 10n. The first classification may mean classification into several groups according to the life pattern of each of users.

The second classification may mean classification into several groups according to the location of each of users. The third classification may mean classification into several groups according to the emotion of each of users. The fourth classification may mean classification into several groups according to the speech of each of users.

The fifth classification may mean classification into several groups according to the action of each of users. The sixth classification may mean classification into several groups according to the movement of each of users. The seventh classification may mean classification into several groups according to the circumstance of each of users. The first to seventh classifications will be described below in detail.

The data calculation module 114 may receive the classification results from the data classification module 113 and may generate personal preference data. The personal preference data may include information about at least one of the user's personality, lifestyle, and hobby. The personal preference data will be described below in detail.

The data calculation module 114 may generate first to n-th pieces of personal preference data in response to data received from each of the plurality of electronic devices 10a to 10n. The data calculation module 114 may output first to n-th pieces of personal preference data to the plurality of electronic devices 10a to 10n through the first device interface 111.

The first storage module 115 may store the first data and the second data. The first storage module 115 may store time-series data generated based on the analysis results of the first data and the second data. The first storage module 115 may store personal preference data generated by classifying the time-series data.

The second server 120 may be implemented in a metaverse environment. In more detail, the second server 120 may provide the plurality of electronic devices 10a to 10n with an actual map or a map abstracted by modeling real-world situations in a virtual environment. The actual map or the abstracted map will be described below in detail.

The second server 120 may include a server interface 121, a data processing module 122, a data graphicalization module 123, a data comparison module 124, a second device interface 125, and a second storage module 126.

The server interface 121 may provide remote communication between the second server 120 and another device not included in the second server 120. The server interface 121 may perform wireless or wired communication between the second server 120 and the other device not included in the second server 120. The other device may include the first server 110.

The data processing module 122 may perform an anonymization operation on the personal preference data received from the first server 110 through the server interface 121. The anonymization operation may be performed on the first data included in the personal preference data.

The data graphicalization module 123 may receive the anonymized personal preference data from the data processing module 122 and then may generate image data in the metaverse environment. The image data may be one 2-dimensional or m-dimensional image data (e.g., ‘m’ is a natural number of 3 or more). The image data will be described below in detail.

The data comparison module 124 may compare first to n-th personal preference data based on the first data and the second data, which are received from each of the plurality of electronic devices 10a to 10n. The data comparison module 124 may output the comparison results to the plurality of electronic devices 10a to 10n.

For example, when outputting the comparison results to the first electronic device 10a, the data comparison module 124 may calculate a difference value by comparing the first personal preference data with each of the second to n-th pieces of personal preference data. The first to n-th pieces of personal preference data may be anonymized data.

As a result, the data comparison module 124 may output personal preference data, which has the smallest difference from the first personal preference data, from among the second to n-th pieces of personal preference data to the first electronic device 10a through the second device interface 125. The data comparison module 124 may be implemented as a management avatar or counselor avatar in the metaverse environment.

The second device interface 125 may provide remote communication between the second server 120 and another device not included in the second server 120. The second device interface 125 may perform wireless or wired communication between the second server 120 and the other device not included in the second server 120. The other device may be the plurality of electronic devices 10a to 10n.

The second storage module 126 may store personal preference data and the anonymized personal preference data. The second storage module 126 may store comparison result data of the data comparison module 124. The second storage module 126 may store image data.

The second server 120 may output candidate avatars and the anonymized first to n-th pieces of personal preference data to the plurality of electronic devices 10a to 10n through the second device interface 125. The number of candidate avatars thus output may be limited based on a user input for the first data.

The second server 120 may receive a user input from each of the plurality of electronic devices 10a to 10n and may output image data corresponding to the selected candidate avatar and the selected personal preference data thus anonymized, to the plurality of electronic devices 10a to 10n.

The user input may be determined based on the comparison result output of the data comparison module 124. Alternatively, regardless of the comparison result output of the data comparison module 124, the user input may be determined based on the anonymized first to n-th pieces of personal preference data.

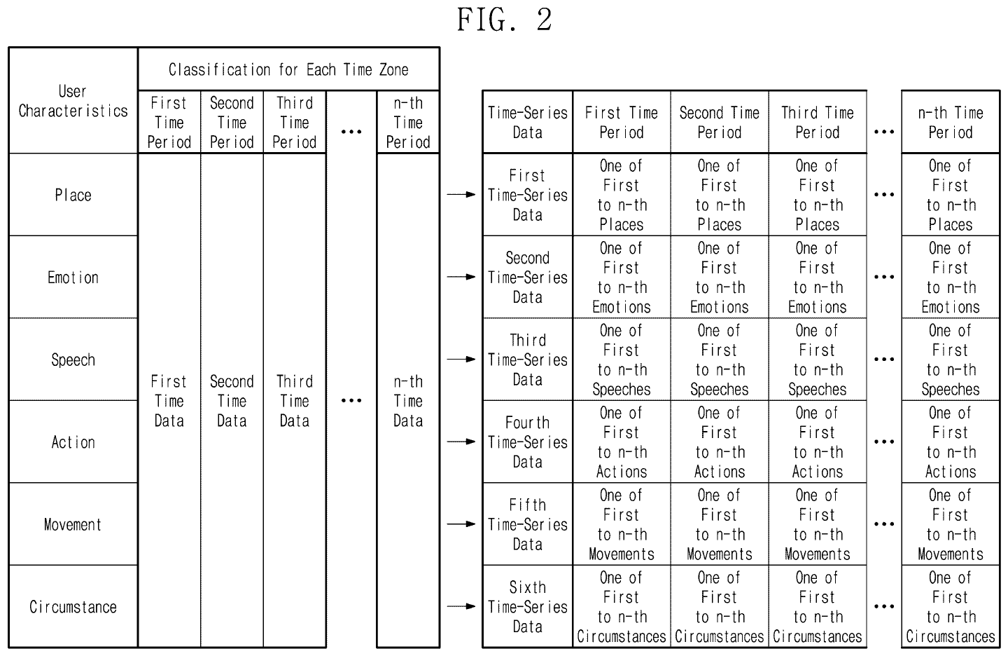

FIG. 2 is a diagram of an embodiment in which a dating recommendation platform generates time-series data. For example, in FIG. 2, each of first to n-th time periods (e.g., ‘n’ is 7) may be a day unit. For example, respective time-series data in FIG. 2 may be data including information about user characteristics for a week.

Referring to FIGS. 1 and 2, the dating recommendation platform 100 may generate characteristic data regarding places, emotions, speeches, actions, movements, and circumstances based on first to seventh pieces of time data respectively received during the first to seventh time periods. The first to seventh pieces of time data may correspond to pieces of second data received during each period in FIG. 1.

The user's place may be one of first to n-th places with respect to each of first to seventh time periods. Each of the first to n-th places may include information about a change pattern of a place and the number of places, each of which is not changed during a specific time period.

However, information about each of the first to n-th places is not limited thereto. First time-series data may include information about seven places the same as or different from each other.

With respect to each of the first to seventh time periods, the user's emotion may be one of the first to n-th emotions. Each of first to n-th emotions may include information about an emotion type and the change pattern of an emotion.

However, information about each of the first to n-th emotion is not limited thereto. Second time-series data regarding an emotion may include information about seven emotions the same as or different from each other.

With respect to each of the first to seventh time periods, the user's speech may be one of the first to n-th speeches. Each of the first to n-th speeches may include information about a speech bandwidth, a speech speed, a speech volume, and a speech pitch.

However, information about each of the first to n-th speeches is not limited thereto. Third time-series data regarding a speech may include information about seven speeches the same as or different from each other.

With respect to each of the first to seventh time periods, the user's action may be one of the first to n-th actions. Each of the first to n-th actions may include information about a basic action such as running, walking, standing, sitting, and lying down, action intensity, and semantic action such as work, sleep, daily organization, leisure, personal care, media, and exercise.

However, information about each of the first to n-th actions is not limited thereto. Fourth time-series data regarding an action may include information about seven actions the same as or different from each other.

With respect to each of the first to seventh time periods, the user's movement may be one of the first to n-th movements. Each of the first to n-th movements may include information about a movement time, a movement distance, and a movement speed.

However, information about each of the first to n-th movements is not limited thereto. Fifth time-series data regarding a movement may include information about seven movements the same as or different from each other.

With respect to each of the first to seventh time periods, the user's circumstance may be one of the first to n-th circumstances. Each of the first to n-th circumstances may include information about noise, temperature, and humidity.

However, information about each of the first to n-th circumstances is not limited thereto. Sixth time-series data regarding a circumstance may include information about seven circumstances the same as or different from each other.

The dating recommendation platform 100 may predict characteristic data based on artificial intelligence including statistical indicators such as standard deviation, entropy, regularity, and intensity with respect to first to seventh pieces of time data.

The dating recommendation platform 100 may generate time-series data by combining user characteristics.

For example, the first time-series data regarding a place may be generated based on information about the user's circumstance with respect to each of the first to seventh time periods. The dating recommendation platform 100 may generate the first time-series data regarding the change pattern of a place based on information about noise in a surrounding environment.

For example, the second time-series data regarding an emotion may be generated based on information about the user's speech with respect to each of the first to seventh time periods. The dating recommendation platform 100 may generate the second time-series data regarding the change pattern of an emotion based on information about the user's speech volume and speech pitch.

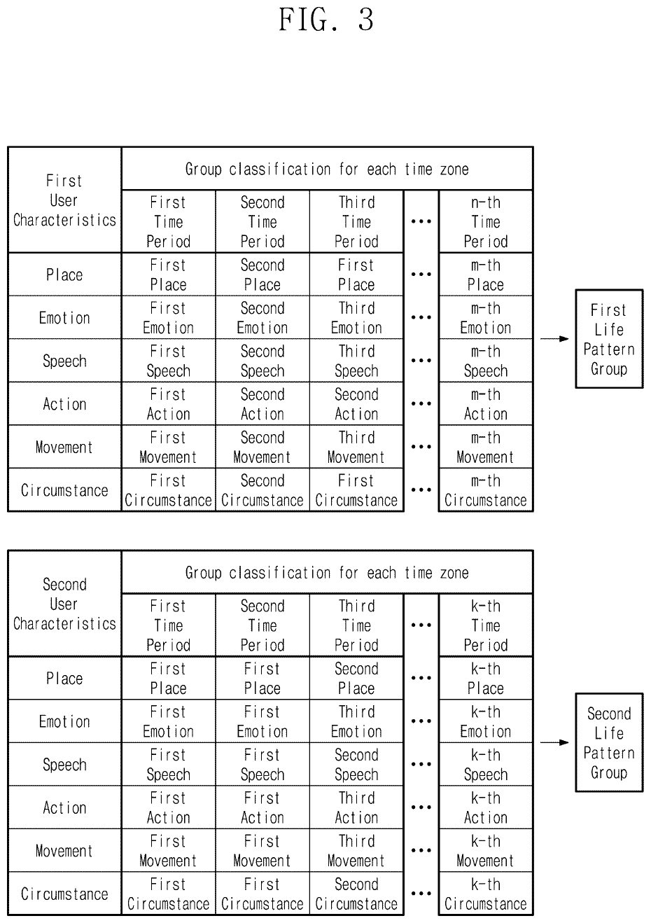

FIG. 3 is a diagram of a first embodiment in which a dating recommendation platform classifies time-series data. For example, in FIG. 3, each of first to n-th time periods (e.g., ‘n’ is 12) may be 2 hours. For example, respective time-series data in FIG. 3 may be data including information about user characteristics for one day.

For example, in FIG. 3, the life pattern classification according to a first user characteristic and a second user characteristic is described. In FIG. 3, the first user characteristic are based on first data and second data received from the first electronic device 10a in FIG. 1, and the second user characteristic are based on first data and second data received from the second electronic device 10b in FIG. 1.

Referring to FIGS. 1 to 3, the dating recommendation platform 100 may generate characteristic data for a first user, which includes information about a first place, a first emotion, a first speech, a first action, a first movement, and a first circumstance during a first time period. On the basis of artificial intelligence, the dating recommendation platform 100 may predict that the first user goes to bed at home during the first time period.

The dating recommendation platform 100 may generate characteristic data for the first user, which includes information about a third place, a first emotion, a third speech, a second action, a third movement, and a second circumstance during a second time period. On the basis of the artificial intelligence, the dating recommendation platform 100 may predict that the first user will move from home to a place where he/she works during the second time period.

The dating recommendation platform 100 may generate characteristic data for the first user, which includes information about the first place, a third emotion, a third speech, the second action, a third movement, and the first circumstance during a third time period. On the basis of the artificial intelligence, the dating recommendation platform 100 may predict that the first user is doing household chores at home during the third time period.

The dating recommendation platform 100 may predict characteristic data of each of the first to third time periods and may classify the first user into a first life pattern group based on a start time point and an end time point of each of the first to third time periods.

The dating recommendation platform 100 may generate characteristic data for a second user, which includes information about the first place, the first emotion, the first speech, the first action, the first movement, and the first circumstance during the first time period. On the basis of the artificial intelligence, the dating recommendation platform 100 may predict that the second user goes to bed at home during the first time period.

The dating recommendation platform 100 may generate characteristic data for the second user, which includes information about the first place, the first emotion, the first speech, the first action, the first movement, and the first circumstance during the second time period. On the basis of the artificial intelligence, the dating recommendation platform 100 may predict that the second user goes to bed at home during the second time period.

The dating recommendation platform 100 may generate characteristic data for the second user, which includes information about the second place, the third emotion, the second speech, the third action, the third movement, and the second circumstance during the third time period. On the basis of the artificial intelligence, the dating recommendation platform 100 may predict that the second user will move from home to a place where he/she works during the third time period.

The dating recommendation platform 100 may predict characteristic data of each of the first to third time periods and may classify the second user into a second life pattern group based on a start time point and an end time point of each of the first to third time periods.

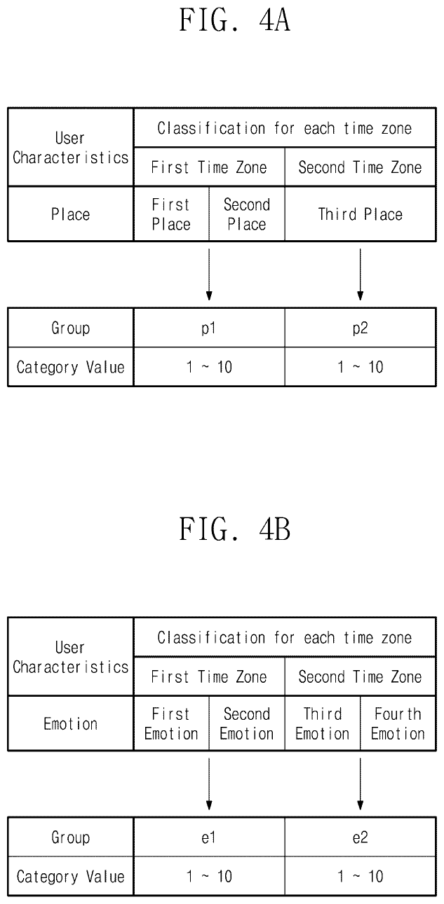

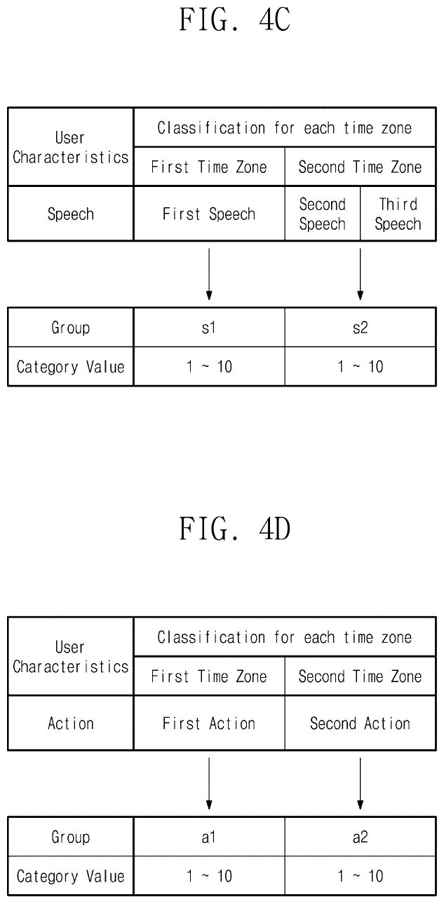

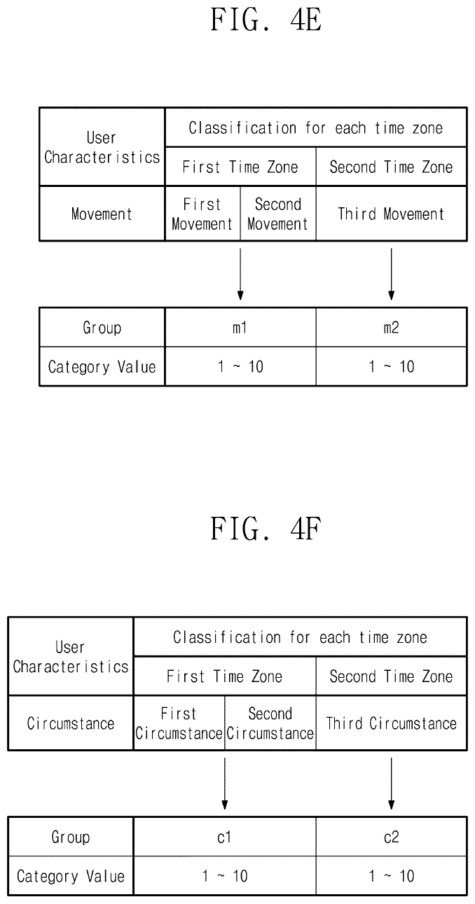

FIG. 4A is a diagram of a second embodiment in which a dating recommendation platform classifies time-series data. For example, in FIG. 4A, each of a first time zone and a second time zone may be 4 hours. The first time zone may include a first period and a second period, each of which is 2 hours.

Referring to FIGS. 1, 2, and 4A, the dating recommendation platform 100 may generate place group data p1 including information about a change from a first place generated at a first period to a second place generated at a second period in the first time zone.

For example, the place group data p1 generated in the first time zone may include information about an extent to which a place changes for each period. When a place changes a lot, a category value may be set to “10”. When a place rarely changes, the category value may be set to “1”. In other words, the category value in a range from 1 to 10 may be set depending on the extent to which the place changes.

The dating recommendation platform 100 may generate place group data p2 including information about a third place generated in the second time zone. For example, the place group data p2 generated in the second time zone may include information about the number of places, at each of which someone stayed during a specific time period or more. The specific time period may be one hour. The category value in a range of “1 to 10” may be set depending on the number of places, at each of which someone stayed during a specific time or more.

FIG. 4B is a diagram of a third embodiment in which a dating recommendation platform classifies time-series data. For example, in FIG. 4B, each of a first time zone and a second time zone may be 4 hours. Each of the first time zone and the second time zone may include a first period and a second period, each of which is 2 hours.

Referring to FIGS. 1, 2, and 4B, the dating recommendation platform 100 may generate emotion group data e1 including information about a change from a first emotion generated at a first period to a second emotion generated at a second period in each of the first time zone and the second time zone.

For example, the emotion group data e1 generated in each of the first time zone and the second time zone may include information about an extent to which an emotion changes for each period. When an emotion changes a lot, a category value may be set to “10”. When an emotion rarely changes, the category value may be set to “1”. In other words, the category value in a range from 1 to 10 may be set depending on the extent to which the emotion changes.

The category value of the emotion group data e1 generated in the first time zone may be the same as or different from the category value of the emotion group data e1 generated in the second time zone.

FIG. 4C is a diagram of a fourth embodiment in which a dating recommendation platform classifies time-series data. For example, in FIG. 4C, each of a first time zone and a second time zone may be 4 hours. The second time zone may include a first period and a second period, each of which is 2 hours.

Referring to FIGS. 1, 2, and 4C, the dating recommendation platform 100 may generate speech group data s1 including information about a first speech generated in the first time zone.

For example, the speech group data s1 generated in the first time zone may include information about an average value of speech speeds. When a speech speed is fast, a category value may be set to “10”. When a speech speed is slow, the category value may be set to “1”. In other words, the category value in a range from 1 to 10 may be set depending on the average value of speech speeds.

The dating recommendation platform 100 may generate speech group data s2 including information about a change from a second speech generated at a first period to a third speech generated at a second period in the second time zone.

For example, the speech group data s2 generated in the second time zone may include information about an extent to which speech volume changes for each period. When the speech volume changes a lot, the category value may be set to “10”. When the speech volume rarely changes, the category value may be set to “1”. In other words, the category value in a range from 1 to 10 may be set depending on the extent to which the speech volume changes.

FIG. 4D is a diagram of a fifth embodiment in which a dating recommendation platform classifies time-series data. For example, in FIG. 4D, each of a first time zone and a second time zone may be 4 hours.

Referring to FIGS. 1, 2, and 4D, the dating recommendation platform 100 may generate action group data a1 including information about a first action generated in the first time zone.

For example, the action group data a1 generated in the first time zone may include information about a work status. When the work status corresponds to work, a category value may be set to “10”. When the work status does not correspond to work, the category value may be set to “1”. In other words, the category value in a range from 1 to 10 may be set depending on the extent to which the work status corresponds to work.

The dating recommendation platform 100 may generate action group data a2 including information about a second action generated in the second time zone.

For example, the action group data a2 generated in the second time zone may include information about an activity status. When there are a lot of activities, a category value may be set to “10”. When there is little activity, the category value may be set to “1”. In other words, the category value in a range from 1 to 10 may be set depending on the activity extent.

FIG. 4E is a diagram of a sixth embodiment in which a dating recommendation platform classifies time-series data. For example, in FIG. 4E, each of a first time zone and a second time zone may be 4 hours. The first time zone may include a first period and a second period, each of which is 2 hours.

Referring to FIGS. 1, 2, and 4E, the dating recommendation platform 100 may generate movement group data m1 including information about a change from a first movement generated at a first period to a second movement generated at a second period in the first time zone.

For example, the movement group data m1 generated in the first time zone may include information about an extent to which a movement time or movement distance changes for each period. When the movement time or movement distance changes a lot, a category value may be set to “10”. When the movement time or movement distance rarely changes, the category value may be set to “1”. In other words, the category value in a range from 1 to 10 may be set depending on the extent to which the movement time or movement distance changes.

The dating recommendation platform 100 may generate movement group data m2 including information about a third movement generated in the second time zone. For example, the movement group data m2 generated in the second time zone may include information about an average value of movement speeds. When the movement speech speed is fast, a category value may be set to “10”. When the movement speed is slow, the category value may be set to “1”. In other words, the category value in a range from 1 to 10 may be set depending on the average value of movement speeds.

FIG. 4F is a diagram of a seventh embodiment in which a dating recommendation platform classifies time-series data. For example, in FIG. 4F, each of a first time zone and a second time zone may be 4 hours. The first time zone may include a first period and a second period, each of which is 2 hours.

Referring to FIGS. 1, 2, and 4F, the dating recommendation platform 100 may generate circumstance group data c1 including information about a change from a first circumstance generated at a first period to a second circumstance generated at a second period in the first time zone.

For example, the circumstance group data c1 generated in the first time zone may include information about an extent to which noise changes for each period. When the noise in a surrounding circumstance changes significantly, the category value may be set to “10”. When the noise of the surrounding circumstance hardly changes, the category value may be set to “1”. In other words, the category value in a range from 1 to 10 may be set depending on the extent to which the noise changes.

The dating recommendation platform 100 may generate circumstance group data c2 including information about a third circumstance generated in the second time zone. For example, the circumstance group data c2 generated in the second time zone may include information about an average value of the noise in a surrounding circumstance. When there is a lot of noise, a category value may be set to “10”. When there is almost no noise, the category value may be set to “1”. In other words, the category value in a range from 1 to 10 may be set depending on the average value of the noise.

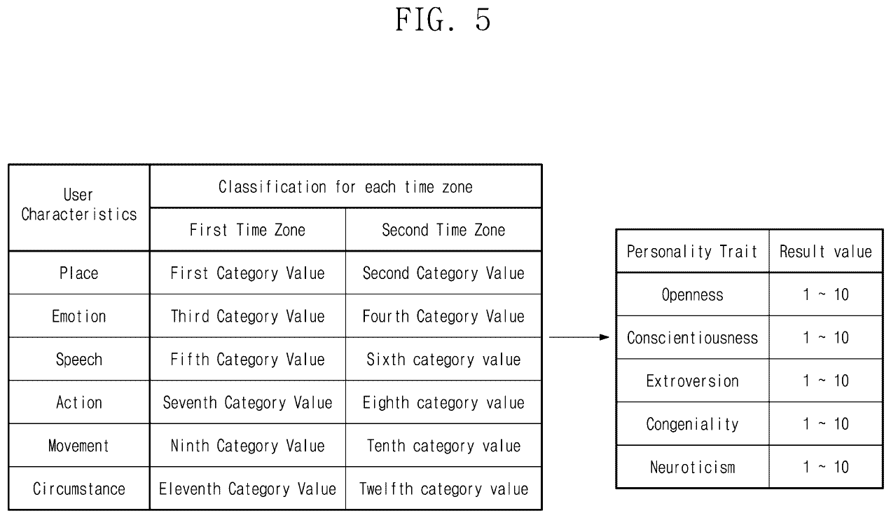

FIG. 5 is a diagram of an embodiment in which a dating recommendation platform generates personal preference data. For example, a first category value of a first time zone for a place in FIG. 5 corresponds to a category value of the place group data p1 in the first time zone of FIG. 4A. For example, a second category value of a second time zone for the place in FIG. 5 corresponds to a category value of the place group data p2 in the second time zone of FIG. 4A.

For example, a third category value of the first time zone for an emotion in FIG. 5 corresponds to a category value of the emotion group data e1 in the first time zone of FIG. 4B. For example, a fourth category value of the second time zone for the emotion in FIG. 5 corresponds to a category value of the emotion group data e2 in the second time zone of FIG. 4B.

For example, a fifth category value of the first time zone for speech in FIG. 5 corresponds to a category value of the speech group data s1 in the first time zone of FIG. 4C. For example, a sixth category value of the second time zone for the speech in FIG. 5 corresponds to a category value of the speech group data s2 in the second time zone of FIG. 4C.

For example, a seventh category value of the first time zone for an action in FIG. 5 corresponds to a category value of the action group data a1 of the first time zone in FIG. 4D. For example, the eighth category value of the second time zone for the action in FIG. 5 corresponds to a category value of the action group data a2 of the second time zone in FIG. 4D.

For example, the ninth category value of the first time zone for a movement in FIG. 5 corresponds to a category value of the movement group data m1 for the first time zone in FIG. 4E. For example, the tenth category value of the second time zone for the movement in FIG. 5 corresponds to a category value of the movement group data m2 of the second time zone in FIG. 4E.

For example, the eleventh category value of the first time zone for a circumstance in FIG. 5 corresponds to a category value of the circumstance group data c1 of the first time zone in FIG. 4F. For example, the twelfth category values of the second time zone for the circumstance in FIG. 5 correspond to a category value of the circumstance group data c2 of the second time zone in FIG. 4F.

Referring to FIGS. 1 to 5, the dating recommendation platform 100 may generate a result value for the first personality trait of openness in the range of between 1 and 10 based on the first to twelfth category values. The dating recommendation platform 100 may generate a result value for the second personality trait of conscientiousness in the range of between 1 and 10 based on the first to twelfth category values.

The dating recommendation platform 100 may generate a result value for the third personality trait of extroversion in the range of between 1 and 10 based on the first to twelfth category values. The dating recommendation platform 100 may generate a result value for the fourth personality trait of congeniality in the range of between 1 and 10 based on the first to twelfth category values. The dating recommendation platform 100 may generate a result value for the fifth personality trait of neuroticism in the range of between 1 and 10 based on the first to twelfth category values.

The dating recommendation platform 100 may generate personal preference data based on the resulting values of openness, conscientiousness, extroversion, congeniality, and neuroticism.

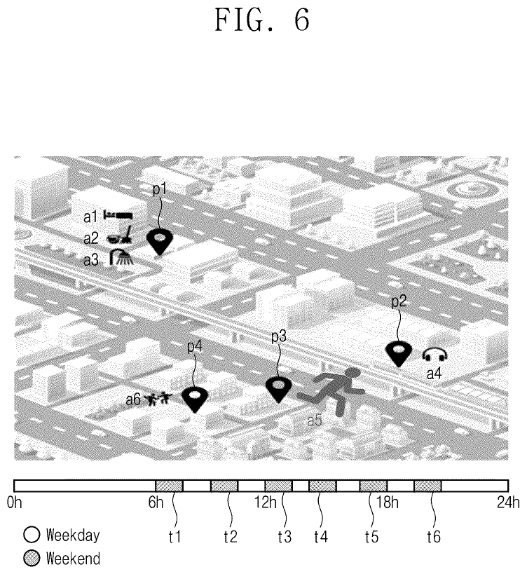

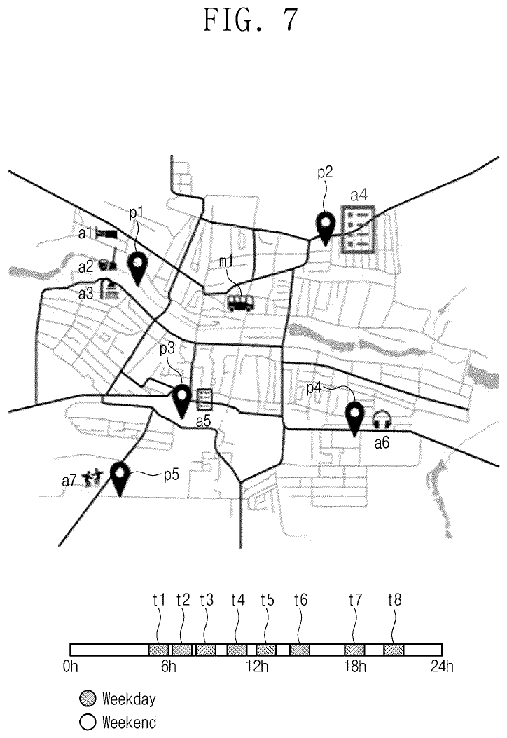

FIG. 6 is a diagram of a first example of image data output by a dating recommendation platform. For example, FIG. 6 shows a user's daily life expressed on an abstract map. FIG. 6 shows the movement of the user's avatar on the abstracted map for each time zone during one day (0 h to 24 h) of a weekend. The user's avatar may be displayed as an icon on the abstracted map.

For example, the size and color of the icon may vary depending on the number of people at the same place as the user or a noise level of the place. For example, when there are a lot of people at the same place as the user, or the place is noisy, the icon may be largely displayed on the abstract map or an actual map.

For example, the size and color of the icon may vary depending on the user's speech time, speech volume, speech speed, or an extent to which these characteristics are changed. For example, when the user's speech time is long, the user's speech volume is high, the user's speech speed is fast, or these characteristics change significantly, the icon may be largely displayed on the abstracted map or the actual map.

For example, the size and color of the icon may vary depending on an extent to which the user's emotion based on the user's sensor data is changed. For example, when the amount of change in the user's emotion is large, the icon may be largely displayed on the abstract map or the actual map.

For example, in FIGS. 6, p1 to p4 may be first to fourth places indicating locations of the avatar for each time zone, respectively. a1 to a6 may be first to sixth actions indicating actions of the avatar for each time zone, respectively. t1 to t6 may be first to sixth time zones, respectively.

Image data may include an avatar that takes the first action a1 at the first place p1 in the first time zone t1. The first action a1 may be sleep. The first place p1 may be the user's home or personal space.

The image data may include an avatar that takes the second action a2 at the first place p1 in the second time zone t2 after the first time zone t1. The second action a2 may be household chores. The image data may include an avatar that takes the third action a3 at the first place p1 in the third time zone t3 after the second time zone t2. The third action a3 may be daily organization.

The image data may include an avatar that takes the fourth action a4 at the second place p2 in the fourth time zone t4 after the third time zone t3. The fourth action a4 may be a media activity. The second place p2 may be a library.

The image data may include an avatar that takes the fifth action a5 at the third place p3 in the fifth time zone t5 after the fourth time zone t4. The fifth action a5 may be exercise. The third place p3 may be a gym.

An avatar that takes the fifth action a5 at the third place p3 in the fifth time zone t5 may be largely displayed in a color different from colors of avatars in the first to fourth time zones t1 to t4. This case may correspond to a case that there are a lot of people located at the same third place p3 as the user in the fifth time zone t5, or a case that the third place p3 is noisy.

The image data may include an avatar that takes the sixth action a6 at the fourth place p4 in the sixth time zone t6 after the fifth time zone t5. The sixth action a6 may be a leisure activity. The fourth place p4 may be an arcade.

FIG. 7 is a diagram of a second example of image data output by a dating recommendation platform. For example, FIG. 7 shows the daily life of a dater in an actual map. FIG. 7 shows the movement of a user's avatar on the actual map for each time zone during one day (0 h to 24 h) of weekdays. The user's avatar may be displayed as an icon on the actual map. Redundant descriptions regarding the size and color of an icon are omitted.

For example, in FIGS. 7, p1 to p5 may be first to fifth places indicating locations of the avatar for each time zone, respectively. a1 to a7 may be first to seventh actions indicating actions of the avatar for each time zone, respectively. t1 to t8 may be first to eighth time zones, respectively.

Image data may include an avatar that takes the first action a1 at the first place p1 in the first time zone t1. The first action a1 may be sleep. The first place p1 may be the user's home or personal space.

The image data may include an avatar that takes the second action a2 at the first place p1 in the second time zone t2 after the first time zone t1. The second action a2 may be household chores. The image data may include an avatar that takes the third action a3 at the first place p1 in the third time zone t3 after the second time zone t2. The third action a3 may be daily organization.

The image data may include an avatar that takes the fourth action a4 at the second place p2 in the fourth time zone t4 after the third time zone t3. The fourth action a4 may be a first task. The second place p2 may be a first work space.

An avatar that takes the fourth action a4 at the second place p2 in the fourth time zone t4 may be largely displayed in a color different from colors of avatars in the first to third time zones t1 to t3. This case may correspond to a case that there are a lot of people located at the same second place p2 as the user in the fourth time zone t4, or a case that the second place p2 is noisy. Alternatively, this case may be the case that a speech speed of the user taking the fourth action a4 is fast, the user's speech volume is high, or the change in the user's emotion is great.

The image data may include an avatar that performs a first movement m1 in the fifth time zone t5 after the fourth time zone t4. The first movement m1 may include information about a movement distance, a movement speed, and a movement time.

The image data may include an avatar that takes the fifth action a5 at the third place p3 in the sixth time zone t6 after the fifth time zone t5. The fifth action a5 may be a second task. The third place p3 may be a second work space.

The image data may include an avatar that takes the sixth action a6 at the fourth place p4 in the seventh time zone t7 after the sixth time zone t6. The sixth action a6 may be a media activity. The fourth place p4 may be a movie theater.

The image data may include an avatar that takes the seventh action a7 at the fifth place p5 in the eighth time zone t8 after the seventh time zone t7. The seventh action a7 may be a leisure activity. The fifth place p5 may be a karaoke room.

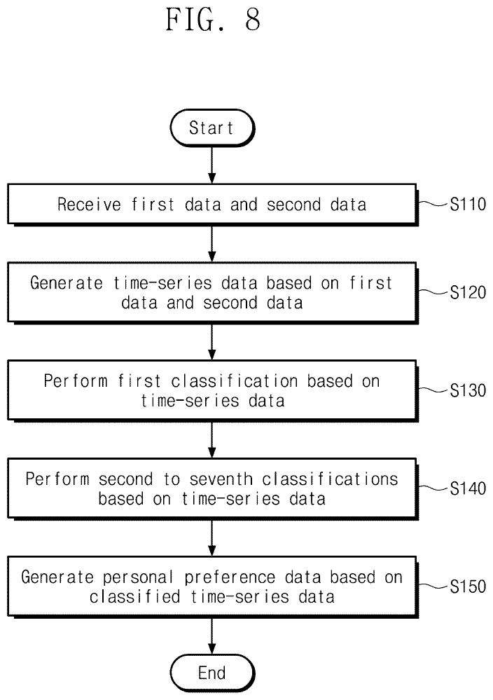

FIG. 8 is a flowchart of an operating method in which a dating recommendation platform generates personal preference data. For example, an operating method of FIG. 8 may be performed by the first server 110.

Referring to FIGS. 1 and 8, in operation S110, the first server 110 may receive first data and second data from the plurality of electronic devices 10a to 10n. The first server 110 may store the first data in advance.

In operation S120, the first server 110 may generate time-series data based on the first data and the second data received for each period. The time-series data may include time-series data regarding each of a place, an emotion, speech, an action, a movement, and a circumstance. The time-series data may include characteristic data including information about at least one of the place, the emotion, the speech, the action, the movement, and the circumstance generated for each period.

In operation S130, the first server 110 may perform a first classification based on the time-series data. The first classification may correspond to classifying the user's life pattern into groups based on the first data and the second data, which are received from each of the plurality of electronic devices 10a to 10n.

In operation S140, the first server 110 may perform second to seventh classifications based on the time-series data. The first server 110 may perform the second to seventh classifications based on the first classification results. The first server 110 may simultaneously perform the second to seventh classifications.

In operation S150, the first server 110 may generate personal preference data based on the first to seventh classification results. The personal preference data may include information about at least one of a personality, a sociality, and a lifestyle.

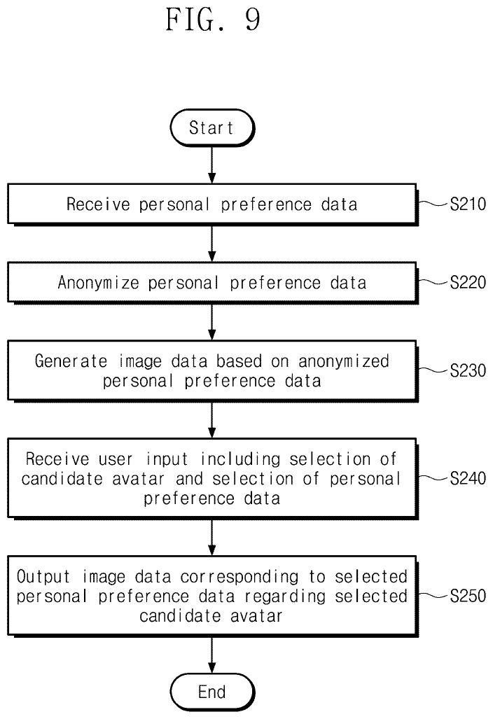

FIG. 9 is a flowchart of an operating method in which a dating recommendation platform outputs image data. For example, an operating method of FIG. 9 may be performed by the second server 120.

Referring to FIGS. 1 and 9, in operation S210, the second server 120 may receive personal preference data from the first server 110. Alternatively, the second server 120 may receive classification results of time-series data from the first server 110.

In operation S220, the second server 120 may perform an anonymization operation on personal preference data. The anonymization operation may mean encrypting the user's personal information such as the user's age, gender, education, and income level in the first data included in the personal preference data.

In operation S230, the second server 120 may generate image data based on the anonymized personal preference data. The image data may be implemented as an abstracted map or an actual map.

In operation S240, the second server 120 may receive a user input including the selection of a candidate avatar and the selection of personal preference data through the second device interface 125.

For example, when the user input is received from the first electronic device 10a, the user input may include at least one of second to n-th personal preference data thus anonymized. The number of candidate avatars may be limited based on a user input to the second to nth personal preference data thus anonymized.

In operation S250, the second server 120 may output, to the plurality of electronic devices 10a to 10n, image data corresponding to the selected personal preference data, to which the candidate avatar selected in response to the user input is reflected.

The above description refers to detailed embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

According to an embodiment of the present disclosure, a dating recommendation platform and an operating method thereof may generate personal preference data by analyzing data collected in real time and may output the personal preference data as image data. Accordingly, accurate personal preference data may be provided to users, and the reliability of the dating recommendation platform may be improved.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A dating recommendation platform comprising:
a first server configured to receive first data and second data from an external electronic device, to generate time-series data including characteristic data generated for each period in response to the first data and the second data by analyzing the second data, and to generate personal preference data by performing a first classification, a second classification, a third classification, a fourth classification, a fifth classification, a sixth classification, and a seventh classification based on the time-series data; and
a second server configured to receive the personal preference data from the first server, to anonymize the first data included in the personal preference data, to generate image data based on the anonymized personal preference data, and to output the generated image data to the external electronic device,
wherein the characteristic data includes information about at least one of an action, an emotion, a place, a speech, a movement, and a circumstance of a user.

2. The dating recommendation platform of claim 1, wherein the first data includes information about at least one of a gender, an age, an area of residence, and an education of the user, and
wherein the second data includes sensor data obtained from sensors included in the external electronic device, user data obtained from an application of the external electronic device, and system data obtained from a device system included in the external electronic device.

3. The dating recommendation platform of claim 1, wherein first time-series data including the place of the user is generated based on the information about the circumstance of the user, and
wherein second time-series data including the emotion of the user is generated based on the information about the speech of the user.

4. The dating recommendation platform of claim 1, wherein the first server generates first characteristic data during a first period, generates second characteristic data during a second period, and generates third characteristic data during a third period,
wherein the first classification includes a classification of a life pattern of the user, and
wherein the first server performs the first classification based on the first characteristic data, the second characteristic data, and the third characteristic data, and a start time point and an end time point of each of the first period, the second period, and the third period.

5. The dating recommendation platform of claim 1, wherein the second classification includes a classification of first time-series data including the place of the user,
wherein the first time-series data includes first place group data and second place group data,
wherein the first place group data has a category value based on a the change value of characteristic data for the place generated during a first time period, and
wherein the second place group data has a category value corresponding to the number of the places generated during a second time period.

6. The dating recommendation platform of claim 1, wherein the third classification includes a classification for second time-series data including the emotion of the user,
wherein the second time-series data includes first emotion group data and second emotion group data,
wherein the first emotion group data has a category value based on a change value of the characteristic data for the emotion generated during a first time period, and
wherein the second emotion group data has a category value based on a change value of the characteristic data for the emotion generated during a second time period.

7. The dating recommendation platform of claim 1, wherein the fourth classification includes a classification for third time-series data including the speech of the user,
wherein the third time-series data includes first speech group data and second speech group data,
wherein the first speech group data has a category value based on an average value of the characteristic data for the speech generated during a first time period, and
wherein the second speech group data has a category value based on a change value of the characteristic data for the speech generated during a second time period.

8. The dating recommendation platform of claim 1, wherein the fifth classification includes a classification for fourth time-series data including the action of the user,
wherein the fourth time-series data includes first action group data and second action group data,
wherein the first action group data has a category value based on the characteristic data for the action generated during a first time period, and
wherein the second action group data has a category value based on the characteristic data for the action generated during a second time period.

9. The dating recommendation platform of claim 1, wherein the sixth classification includes a classification for fifth time-series data including the movement of the user,
wherein the fifth time-series data includes first movement group data and second movement group data,
wherein the first movement group data has a category value based on a change value of the characteristic data for the movement generated during a first time period, and
wherein the second movement group data has a category value based on an average value of the characteristic data for the movement generated during a second time period.

10. The dating recommendation platform of claim 1, wherein the seventh classification includes a classification for sixth time-series data including the circumstance of the user,
wherein the sixth time-series data includes first circumstance group data and second circumstance group data,
wherein the first circumstance group data has a category value based on a change value of the characteristic data for the circumstance generated during a first time period, and
wherein the second circumstance group data has a category value based on an average value of the characteristic data for the circumstance generated during a second time period.

11. The dating recommendation platform of claim 1, wherein the second server outputs the anonymized personal preference data to the external electronic device,
wherein the second server receives a user input including a selection of a candidate avatar and a selection of the anonymized personal preference data from the external electronic device, and
wherein the second server outputs the image data corresponding to the selected personal preference data for the selected candidate avatar to the external electronic device.

12. An operating method of a dating recommendation platform including a first server and a second server, the method comprising:
receiving, by the first server, first data and second data from an external electronic device;
generating, by the first server, time-series data corresponding to the first data and the second data by analyzing the second data;
generating, by the first server, personal preference data by performing a first classification, a second classification, a third classification, a fourth classification, and a fifth classification based on the time-series data;
anonymizing, by the second server, the first data included in the personal preference data;
generating, by the second server, image data based on the anonymized personal preference data; and
outputting, by the second server, the generated image data to the external electronic device.

13. The method of claim 12, wherein the time-series data includes characteristic data generated for the respective period in response to the second data, and
wherein the characteristic data includes information about at least one of an action, an emotion, a place, a speech, a movement, and a circumstance of a user.

14. The method of claim 13, wherein the generating of the time-series data includes:
generating, by the first server, first characteristic data during a first period, generating second characteristic data during a second period, and generating third characteristic data during a third period, and
wherein the generating of the personal preference data includes:
performing, by the first server, a first classification on a life pattern of the user based on the first characteristic data, the second characteristic data, and the third characteristic data, and a start time point and an end time point of each of the first period, the second period, and the third period.

15. The method of claim 13, wherein the performing of the second classification includes:
classifying, by the first server, first time-series data including the action of the user,
wherein the first time-series data includes first action group data and second action group data,
wherein the first action group data has a category value based on the characteristic data for the action generated during a first time period, and
wherein the second action group data has a category value based on the characteristic data for the action generated during a second time period.

16. The method of claim 13, wherein the performing of the third classification includes:
classifying, by the first server, second time-series data including the movement of the user,
wherein the second time-series data includes first movement group data and second movement group data,
wherein the first movement group data has a category value based on a change value of the characteristic data for the movement generated during a first time period, and
wherein the second movement group data has a category value based on an average value of the characteristic data for the movement generated during a second time period.

17. The method of claim 13, wherein third time-series data including the place of the user is generated based on the information about the circumstance of the user, and
wherein fourth time-series data including the emotion of the user is generated based on the information about the speech of the user.

18. The method of claim 17, wherein the performing of the fourth classification includes:
classifying, by the first server, the third time-series data including the place of the user,
wherein the third time-series data includes first place group data and second place group data,
wherein the first place group data has a category value based on a change value of the characteristic data for the place generated during a first time period, and
wherein the second place group data has a category value corresponding to the number of the places generated during a second time period.

19. The method of claim 17, wherein the performing of the fifth classification includes:
classifying, by the first server, the fourth time-series data including the emotion of the user,
wherein the fourth time-series data includes first emotion group data and second emotion group data,
wherein the first emotion group data has a category value based on a change value of the characteristic data for the emotion generated during a first time period, and
wherein the second emotion group data has a category value based on a change value of the characteristic data for the emotion generated during a second time period.

20. The method of claim 12, further comprising:
outputting, by the second server, the anonymized personal preference data to the external electronic device;
receiving, by the second server, a user input including selection of a candidate avatar and selection of the anonymized personal preference data from the external electronic device; and
outputting, by the second server, the image data corresponding to the selected personal preference data for the selected candidate avatar to the external electronic device.
